(19) United States
(12) Patent Application Publication
(10) Pub. No.: US 2016/0243552 A1
(43) Pub. Date: Aug. 25, 2016

(54) RECEIVING ARRANGEMENT OF A CRUSHER TOOTH ON A CRUSHER ROLL OF A CRUSHER

(71) Applicant: THYSSENKRUPP INDUSTRIAL SOLUTIONS AG, Essen (DE)

(72) Inventors: Guido Leuschen, Bielefeld (DE); Piotr Szczelina, Beckum (DE); Bernhard FUHRMANN, Gütersloh (DE); Detlef PAPAJEWSKI, Bochum (DE)

(73) Assignee: ThyssenKrupp Industrial Solutions AG, Essen (DE)

(21) Appl. No.: 15/028,279

(22) PCT Filed: Oct. 9, 2014
(86) PCT No.: PCT/EP2014/002741

§ 371 Date: Apr. 8, 2016

(30) Foreign Application Priority Data
Oct. 14, 2013 (DE) 10 2013 111 312.5

(51) Int. Cl. B02C 4/30

(52) U.S. Cl. CPC B02C 4/305; B02C 2210/02

(57) ABSTRACT

An example arrangement on a crushing roller of a crusher may be configured to receive a crusher tooth that is used to generate a crushing action. The crusher tooth may project at least partially out of a surface of the crushing roller. In some examples, the crushing roller may include a receiving pocket that receives a tooth root of the crusher tooth. Moreover, at least one bracing means may be disposed in the receiving pocket substantially or completely recessed beneath the surface of the crushing roller. The bracing means may help brace the tooth root in the receiving pocket. In some cases, a fastener may be used to secure the bracing means in the receiving pocket.

The present invention relates to an arrangement for accommodating a crusher tooth on a crushing roller of a crusher, wherein the crusher tooth, for generating a crushing action, projects, at least in part, out of the surface of the crushing roller.

### PRIOR ART

It is possible for crushing rollers, for generating a crushing action, to be equipped directly with crusher teeth; however, it is often also the case that crushing rollers are equipped with so-called crushing plates, on which are fitted the crusher teeth for generating the crushing action. The crusher teeth here project beyond the surface of the crushing roller, or the crushing plates, in order to generate, by rotation of the crushing roller, a crushing action against material which is to be crushed. It is often the case that two crushing rollers are arranged parallel to one another and made to rotate, and the material which is to be crushed is introduced into a gap between the two crushing rollers in order to be comminuted. Crushers within the context of the present invention thus relate to crushers with rather slow-rotation crushing rollers which achieve a crushing action with very high crushing forces being generated in the process. The very high crushing forces here act on the crusher teeth arranged on the crushing roller, or on the crushing plates, and therefore the arrangement for accommodating the crusher teeth on the crushing roller has to meet certain requirements. Crushers within the context of the present invention thus relate, in particular, also to so-called sizers. Within the context of the present invention, and in accordance with predominant linguistic usage, the arrangement for accommodating a crusher tooth on a crusher relates both to the crusher tooth being accommodated on a crushing plate, for its part fastened on the body of the crushing roller, and to the crusher tooth being accommodated on the body of the crushing roller itself. The term crushing roller, which is used hereinbelow, therefore always also covers the term crushing plate.

In the region of the crushers and of the sizers, the crusher teeth are often fitted on the crushing rollers such that the crusher teeth, after reaching a degree of wear, can be removed again. As a result of the very high mechanical loading to which the crusher teeth are subjected, the latter undergo wear and often have to be changed over on a monthly or annual cycle. At the same time, it is possible for very high loads to act on the crusher teeth, both centrally and obliquely, as a result of the crushing processes. In particular the oblique loading to which the crusher teeth are subjected means that the strength of the crusher teeth and of the accommodating arrangement for fastening the crusher teeth on the roller, or on the crushing plate, has to meet very stringent requirements; however, the accommodating arrangement should take up the smallest possible amount of installation space, and it is not possible for the crusher teeth to have their tooth root accommodated, for example, to a fundamentally very low level in the crushing roller.

In the case of the crusher teeth being changed over on site, the arrangement for accommodating the crusher teeth on the crushing roller additionally has to meet requirements which allow the crusher teeth to be accommodated on the crushing roller in a manner which can be released quickly, to be produced with low outlay and can be subjected to high loading. In particular the quick removal of crusher teeth from the crushing roller, and quick installation of crusher teeth in the crushing roller, is important crushing rollers with a large number of crusher teeth, in order to keep the stoppage times of the crusher as short as possible. It is also the case that the geometry of the crusher teeth should be of as straightforward and universal a configuration as possible, and the operation of fitting the crusher teeth on the crushing roller should be capable of being carried out as far as possible by straightforward means.

It should be possible for the accommodating geometries on the crushing roller to be produced as far as possible with low outlay and only a small number of machining steps, and easy access to the machining surfaces should be provided. For example, crushing rollers which have to be armored at regular time intervals are known, and it is therefore necessary to access the crushing plates for armoring purposes. Accommodating structures which are intended for arranging the crusher teeth on the crushing roller and project out of the surface of the crushing roller should therefore be avoided.

The materials of the crusher teeth nowadays, for reasons relating to wear, are formed by extremely hard materials which involve very high outlay to machine. Examples here are hard metals, ceramics, ultrahigh-strength steels and combinations thereof. Avoiding, or minimizing, machining of the teeth is therefore a pressing issue from the point of view of cost, and so the crusher teeth themselves should be of fairly straightforward, for example cuboidal, trapezoidal or cubic shapes and high-outlay retaining geometries should be dispensed with.

It is also known, for example, for the crusher teeth to be welded directly to the crushing rollers by means of thermal joining techniques and, once the limit service life has been reached, the crusher teeth are cut off and new crusher teeth are welded on again. The thermomechanical follow-up work which is necessary here as well as the high-outlay joining processes vastly increase the costs of the wear parts. Attempts to fasten a tooth in a holder by means of a pin were not able to demonstrate sufficient loading capability in relation to high comminuting forces introduced obliquely. It is therefore possible for the operation of pinning the crusher teeth in a holder to be used merely for crushers which are subjected only to lower loads.

It is therefore a requirement, for the straightforward provision of crushing rollers for accommodating crusher teeth, that, as far as possible, no accommodating structures project beyond the surface of the crushing roller since it is also the case that structures projecting beyond the surface undergo wear, since said structures, like the crusher tooth, can come into contact with the material which is to be crushed. In addition, there is an increase in production outlay for the crushing rollers.

Therefore, for example DE 41 23 967 A1 discloses an arrangement for accommodating a crusher tooth on a crushing roller of a crusher, the crusher teeth being screw-connected from the rear side of the crushing plates. In addition, the crushing plates have an accommodating structure which projects beyond the surface of the crushing roller, this therefore giving rise to the disadvantages described above.

EP 0 640 396 B1 discloses an impact crusher with a rotor, which has impact bars fastened by one or more bracing wedges in impact-bar mounts of the rotor. The impact bars have root regions, which extend into an accommodating pocket in the crushing roller and are wedged by way of a bracing wedge. Such an arrangement, however, can only be realized using a further component, which forms an abutment beam, which is arranged on the periphery of the accommodating pocket by thermal jointing techniques. It is also necessary to have a delimiting plate, in order to delimit the outer opening of the accommodating pocket from a side opposite the abutment beam. The arrangement for accommodating the impact bar is thus of very high-outlay configuration and, in impact crushers, maximum forces to which the tool regions projecting beyond the surface of the crushing roller are subjected are considerably lower, and therefore an arrangement of an impact bar cannot be developed in order for crusher teeth to be fitted in the same, or a similar, manner on the crushing roller of a crusher or of a sizer. In particular as the impact bars are formed over the entire crushing-space width, the oblique loads which take effect are very low in relation to the crusher teeth of a crusher.

### DISCLOSURE OF THE INVENTION

It is an object of the invention to improve an arrangement for accommodating a crusher tooth on a crushing roller of a crusher, wherein the accommodating arrangement should be of as straightforward as possible a configuration, should be produced with minimal machining steps in the crushing roller, or in a crushing plate, and the arrangement of the crusher tooth on the crushing roller should withstand the highest possible loading, but it should be possible for the crusher tooth to be changed over as straightforwardly and quickly as possible.

This object is achieved, on the basis of an arrangement for accommodating a crusher tooth on a crushing roller of a crusher according to the preamble of claim 1, in conjunction with the characterizing features. Advantageous developments of the invention are specified in the dependent claims.

The invention includes the technical teaching that an accommodating pocket is incorporated in the crushing roller, wherein the crusher tooth has a tooth root, which extends into the accommodating pocket, and wherein at least one bracing means is arranged essentially beneath the surface of the crushing roller and is accommodated in the accommodating pocket, the bracing means bracing the tooth root in the accommodating pocket.

The solution according to the invention thus resides in shifting the accommodating arrangement beneath the surface of the crushing roller, and an additional holder fitted on the crushing roller is omitted. It is thus possible for machining to take place straightforwardly beneath the surface of the crushing roller, without problematic elevated structures having to be negotiated. The straightforward formation of an accommodating pocket which is open in the upward direction ensures ready access to the machining zones. It is also possible for the plates to be armored with low outlay. In a simplest, and therefore preferred, case, it is possible for the accommodating pockets, for accommodating the crusher teeth via their tooth roots, to have rectangular depressions with a, for example, planar pocket base, the accommodating pockets thus being produced very straightforwardly by a milling operation. For example, it is possible for a single milling operation to be sufficient for forming an accommodating pocket in the crushing roller or in the crushing plate.

At the same time, weak points of an elevated holder in the form of reduced wall thicknesses and unfavorable notch effects are avoided. This makes it possible for the loading capability of the crusher teeth and of the accommodating arrangements in relation to loads which are introduced obliquely to be vastly increased. The very straightforward geometry which can be exhibited by the crusher teeth with their tooth roots makes it possible to provide the teeth with straightforward embodiments of crushing rollers by being cut out, for example burnt out by thermal means, of a thick steel sheet; it is likewise also possible, however, for the accommodating pockets to accommodate highly armored teeth with hard metal, ceramics or other materials in the accommodating pockets.

As a result of the solution according to the invention, the crusher tooth is lengthened to a certain extent by its crushing root, which extends in beneath the surface of the crushing roller, and it is possible for the tooth root to be wedged mechanically within the accommodating pocket. The very high loading which occurs can be introduced into the crushing roller here directly from the crusher tooth, via the tooth roots, without there being any need for screw connections or any further connecting means for absorbing the high forces. The crusher teeth can be changed over here, manually or robotically, within a very short period of time. It is possible for the robotic means both to be used for the bracing means, for example releasing and tightening the bracing wedge or the wedging lock, and to carry out removal and insertion of the crusher tooth in particular in a fully automated manner.

The tooth root of the crusher tooth and the bracing means can particularly advantageously be incorporated in the accommodating pocket adjacent to one another. The bracing means may be arranged behind the position of the crusher tooth in the accommodating pocket, as seen in relation to a direction of rotation of the crushing roller; in particular, the accommodating pocket may be of elongate configuration, as seen in relation to the direction of rotation, and the length of the accommodating pocket corresponds to the length achieved by arranging the bracing means behind the arrangement of the tooth root. It is possible here for the width of the accommodating pocket to correspond to the width of the tooth root, and for the bracing means to be adapted to the width of the tooth root, wherein the width direction corresponds to the direction in which the axis of rotation of the crushing roller extends.

This gives rise to a rectangular accommodating pocket with a preferably planar pocket base. The rectangular configuration within the context of the present invention, however, may include corners with radii or milled grooves, which are necessary for production reasons or for accommodating the tooth root and the bracing means. At any rate, a rectangular basic shape of the accommodating pocket in the crushing roller can advantageously be achieved. Despite the curvature of the surface of the crushing roller, it is possible here for the accommodating pocket to have a preferably planar pocket base. Such an accommodating pocket can thus be produced in the surface of the crushing roller by a straightforward milling operation.

Furthermore, the accommodating pocket may have a pocket wall, wherein the bracing means braces the tooth root against the pocket wall. The accommodating pocket can be delimited by a further pocket wall, which is located opposite and against which the bracing means is supported in the same manner, and therefore providing the bracing means between the two pocket walls can give rise to bracing actions, which brace the tooth root in the accommodating pocket. In particular it is possible for the tooth root to be braced in the accommodating pocket by the bracing means, with a form fit being formed in the process. The crusher tooth can be retained against the surface of the pocket wall by means of at least two further options. On the one hand, there is the option of a small amount of play being provided between the tooth root and the pocket wall, wherein the amount of play can be adjusted, for example, using shims. On the other hand, there is the option of providing slight wedging action by way of a slope on the tooth root or on the bracing wedge, as will be described in more detail hereinbelow.

In order to form the form fit, it is possible for the tooth root to have, for example, a shaped portion which projects from a basic shape of the crusher tooth and, along with in particular sloping orientation of the pocket wall, forms a form fit between the tooth root and the accommodating pocket. For example the projecting shaped portion on the tooth root and a pocket wall opening inward into the accommodating pocket can give rise to the tooth root being accommodated in the manner of a dovetail configuration in the accommodating pocket.

According to a possible advantageous embodiment, the bracing means may be formed by a bracing wedge, which is braced against the tooth root by at least one screw-action element. The bracing wedge may have a wedge surface by means of which the bracing wedge presses against an in particular planar-abutment pressure-exerting surface on the tooth root, said pressure-exerting surface corresponding to the wedge surface, and in particular slides on the same when the bracing wedge is braced against the tooth root.

According to a possible embodiment for bracing the bracing wedge against the tooth root, it is possible for the pocket base of the accommodating pocket to have incorporated in it at least one threaded bore, in which the screw-action element is screwed, and therefore the bracing wedge is drawn into the accommodating pocket in the direction of the pocket base by virtue of the screw-action element being screwed into the threaded bore. It is also possible here to provide two or more screw-action elements per bracing wedge, with associated threaded bores, the bracing wedge possibly being of, for example, elongate configuration and extending along the pressure-exerting surface on the tooth root. The screw-action elements may be guided, in particular, through a through-bore in the bracing wedge. For releasing the bracing wedge, it is possible to provide forcing screws, which can be screwed into associated threaded passages in the bracing wedge. If the forcing screws are screwed into the threaded passages in the bracing wedge and braced against the pocket base, then it is possible to release the bracing wedge from being braced with the tooth root.

According to an alternative embodiment, the bracing wedge can be braced away from the pocket base by the screw-action element, this likewise generating clamping action of the bracing wedge with the tooth root in the accommodating pocket. It is even possible here for the tooth root to be forced away slightly from the pocket base of the accommodating pocket, this likewise making it possible to achieve a form fit of the crusher tooth in the accommodating pocket. For example, it is possible for one or more screw-action elements to be screwed into associated threaded bores in the bracing wedge, and the screw-action elements use an end-side pressure-exerting surface to force the bracing wedge away from the pocket base.

According to a further variant of the accommodating arrangement according to the invention, the bracing means may be formed by a wedging lock, which has a rotary element and two pressure-exerting jaws, wherein the pressure-exerting jaws can be forced apart from one another by rotation of the rotary element, this generating a clamping action of the tooth root in the accommodating pocket. The rotary element may have, for example, a worm contour with an upwardly sloping radius, as seen in relation to the axis of rotation of the rotary element, or it may be eccentric, and, in the case of the rotary element being rotated, for example through 90° or 180°, the pressure-exerting jaws are forced apart from one another slightly and a first pressure-exerting jaw can press against a pocket wall and the opposite, second pressure-exerting jaw can press against a pressure-exerting surface of the tooth root of the crusher tooth. This results in a crusher tooth being braced in the accommodating pocket, and the wedging lock can easily be released again by virtue of the rotary element being rotated back.

In particular it is possible for the rotary element to have a tool mount for accommodating a turning tool, by means of which the wedging lock can be rotated manually, and in particular robotically, between a closed position and an open position.

It is possible here for example for the straightforward use of the tool for wedging, and for releasing, the wedging lock to shorten further the amount of time taken to change over crusher teeth on the crushing roller, and the changeover operation can be carried out manually or even fully robotically. The worm contour here can convert the straightforward rotary movement of the rotary element into a linear movement. It is possible here for a rotation of, for example, up to 180° to ensure sufficient clamping action of the crusher tooth. Care should be taken here that the flow of forces moves, as far as possible, rectilinearly through the wedging lock. In particular it is possible to safeguard against the rotary elements coming loose, and the necessary clamping force can be ensured via a predetermined torque.

The fully robotic operation of the wedging lock may also comprise, for example, automatic detection of the position of the crusher teeth and of the wedging lock on the basis of, for example, optical or radio-technology systems. For example it is possible for the wedging locks to be provided with RFID technology, which communicates with a corresponding transponder on the robotic tool.

In order to protect the bracing means, which, as described above, may be configured for example in the form of a bracing wedge or in the form of a wedging lock, it is possible to provide a cover, which is fastened above the accommodating pocket on the crushing roller. The cover here may be configured such that it protects the bracing means and possibly associated screw-action elements against mechanical influences, since only the tooth projects out of the cover.

### PREFERRED EXEMPLARY EMBODIMENTS OF THE INVENTION

Further measures, which improve the invention, are presented in more detail hereinbelow, together with the description of a preferred exemplary embodiment of the invention, with reference to the figures, in which:

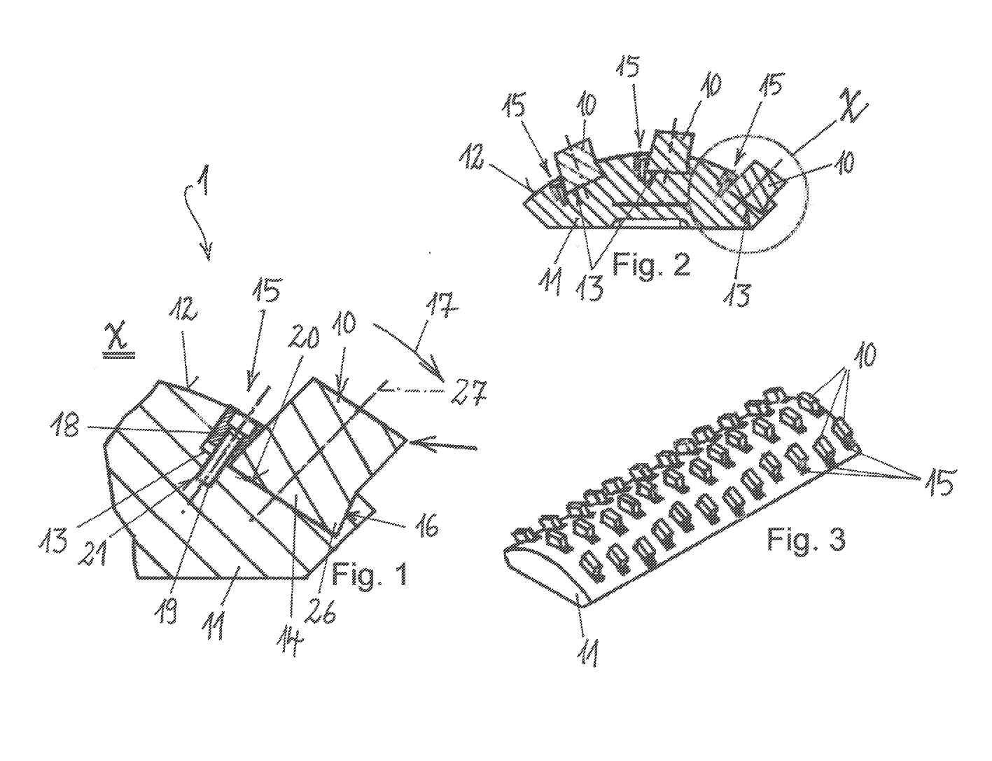

FIG. 1 shows a cross-sectional view of a first exemplary embodiment of the arrangement for accommodating a crusher tooth on a crushing roller,

FIG. 2 shows a cross-sectional view through part of a crushing roller on which a plurality of crusher teeth are accommodated,

FIG. 3 shows a perspective view of a crushing roller having a plurality of crusher teeth arranged one beside the other and one behind the other on the crushing roller,

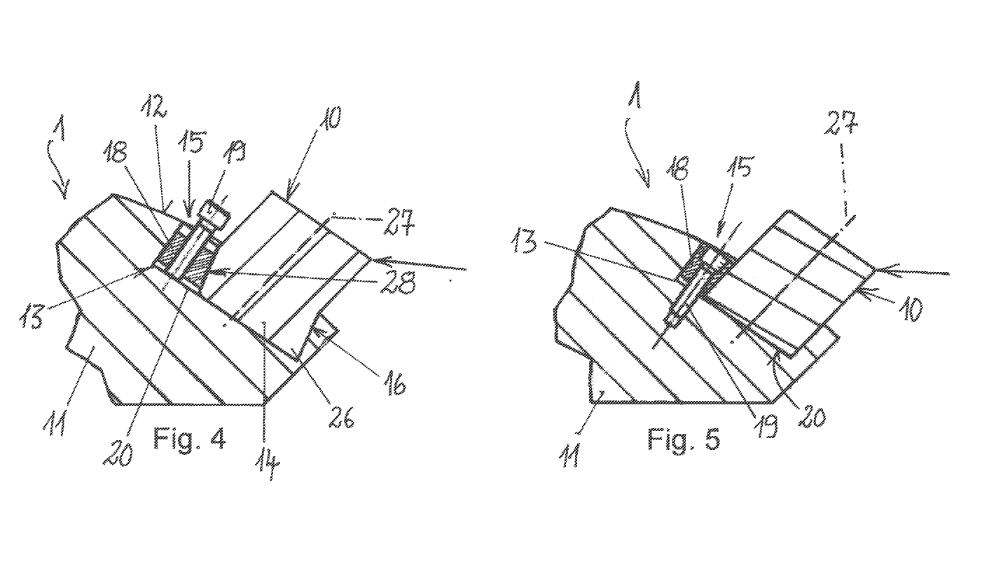

FIG. 4 shows a further exemplary embodiment of an arrangement for accommodating a crusher tooth on a crushing roller, having a bracing means which is configured in the form of a bracing wedge,

FIG. 5 shows a further exemplary embodiment of the accommodating arrangement, having a bracing wedge in a different bracing arrangement,

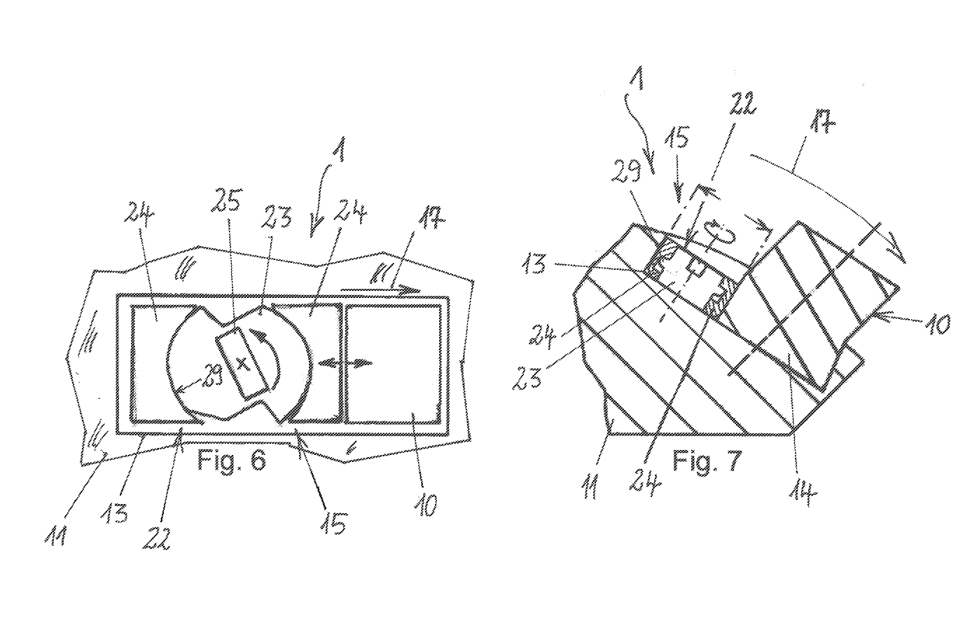

FIG. 6 shows a plan view of a further exemplary embodiment of an accommodating arrangement, having a bracing means which is configured in the form of a wedging lock, and

FIG. 7 shows a cross-sectional view of the exemplary embodiment of the accommodating arrangement having a wedging lock according to FIG. 6.

FIG. 1 shows a cross-sectional view of an exemplary embodiment of an arrangement 1 for accommodating a crusher tooth 10 on a crushing roller 11 of a crusher having the features of the present invention. The crushing roller 11 is shown only in part and can also form, in the same way, a crushing plate, which is accommodated on a crushing roller and serves for accommodating a plurality of crusher teeth 10 individually.

An accommodating pocket 13 is incorporated in the crushing roller 11, and the accommodating pocket 13 may be produced, for example, by milling. The accommodating pocket 13 thus forms an accommodating space beneath the surface 12 of the crushing roller 11, and the accommodating pocket 13 has a pocket base 20, wherein, on one side, the reference sign 16 designates a pocket wall which extends from the pocket base 20 to the surface 12.

The crusher tooth 10 shown has a tooth root 14, wherein the tooth root 14 merges integrally into that part of the crusher tooth 10 which projects beyond the surface 12 of the crushing roller 11. Within the context of the present description, the tooth root 14 forms that part of the crusher tooth 10 which is beneath the surface 12 of the crushing roller 11, and the tooth root 14 rests on the pocket base 20 of the accommodating pocket 13. It is also the case that the tooth root 14 has an abutment side butting against the pocket wall 16, wherein the abutment side of the tooth root 14 has a projecting shaped portion 26, which forms a slope which corresponds with the slope of the pocket wall 16 and, as seen in relation to the longitudinal direction 27 of the tooth, forms a dovetail-configuration form fit.

Also shown is a direction of rotation 17, in which the crushing roller 10 rotates during operation of the crusher, and crushing forces acting on the crusher tooth 10 have a force direction which, as shown by a depicted force arrow, act on the crusher tooth 10 from the front side of the latter, and therefore the forces acting on the crusher tooth 10 can be absorbed in particular by the form fit between the pocket wall 16 and the projecting shaped portion 26 in the tooth root 14.

In relation to the direction of rotation 17, the rear side of the crusher tooth 10 has located on it a bracing means 15, which, according to the exemplary embodiment, is formed by a bracing wedge 18. The bracing wedge 18 butts against a further pocket wall, located opposite the pocket wall 16, and a further side of the bracing wedge 18 butts against a pressure-exerting surface on the tooth root 14. By virtue of the screw-action element 19 which is shown, and is screwed into a threaded bore 21 in the crushing roller 11, the bracing wedge 18 is drawn into the accommodating pocket 13 in the direction of the pocket base 20. As a result, the wedge surface of the bracing wedge 18 slides on the pressure-exerting surface of the tooth root 14, and the crusher tooth 10 is braced between the pocket wall 16 and the bracing wedge 18.

FIG. 2 shows a plurality of crusher teeth 10 arranged on a crushing roller 11, wherein detail X represents the illustration in FIG. 1, and it can be seen that each crusher tooth 10 is assigned an accommodating pocket 13 and a bracing means 15, and the bracing means 15 are located beneath the surface 12 of the crushing roller 11, within the accommodating pockets 13.

FIG. 3 shows a perspective view of part of a crushing roller 11 having a number of crusher teeth 10 which are distributed one behind the other and one beside the other on the crushing roller 11 and are braced on the crushing roller 11 by way of respective bracing means 15.

FIG. 4 shows a further exemplary embodiment of the accommodating arrangement 1, and the bracing means 15 shown for bracing the crusher tooth 10, by way of the tooth root 14, within the accommodating pocket 13, is likewise configured in the form of a bracing wedge 18. The tooth root 14 is formed with a projecting shaped portion 26, which, along with a pocket wall 16, forms an undercut, as seen in relation to a longitudinal direction 27 of the tooth. The bracing wedge 18 is located on the rear side of the crusher tooth 10, wherein the bracing wedge 18 is braced against a negative wedge surface 28 of the tooth root 14. The negative wedge surface 28 causes the space for accommodating the bracing wedge 18 to be narrowed upward in the direction of the surface 12 of the accommodating pocket 13. A screw-action element 19 is screwed into the bracing wedge 18 and forces the bracing wedge 18 away from the pocket base 20 of the accommodating pocket 13, and therefore the bracing wedge 18, together with the tooth root 14, tilts in the accommodating pocket 13. This means that even the foot of the tooth root 14 can lift off slightly from the pocket base 20. The pocket wall 16 with a slope, which corresponds with the projecting shaped portion 26, results in the formation of a form fit with clamping action, and therefore forces which occur, shown by an arrow pointing toward the crusher tooth 10, can be introduced into the crushing roller 11 via the bracing wedge 18.

A further exemplary embodiment of the accommodating arrangement 1 is shown in FIG. 5, which is a cross-sectional view of an accommodating pocket 13 in a crushing roller 11, a crusher tooth 10 with a tooth root 14 being accommodated in the accommodating pocket 13; also shown is a bracing means 15 in the form of a bracing wedge 18, which, as already described in conjunction with FIG. 1, is drawn into the accommodating pocket 13, toward the pocket base 20, by way of a screw-action element 19. The exemplary embodiment of the crusher tooth 10 shows a tooth shape with a cross section which remains constant along the longitudinal direction 27. The base surface of the crusher tooth 10 here is designed to be sloping in relation to the longitudinal direction 27 of the tooth, but it butts in planar fashion against the pocket base 20 of the accommodating pocket 13. Bracing of the crusher tooth 10 by the bracing means 15 gives rise to clamping action of the crusher tooth 10, said clamping action, despite high mechanical loading in the arrow direction shown pointing toward the crusher tooth 10, accommodating said crusher tooth firmly in the accommodating pocket 13.

FIGS. 6 and 7 show a plan view and a cross-sectional view of a further exemplary embodiment of an accommodating arrangement 1, having bracing means 15 which are configured in the form of a wedging lock 22. The bracing means 15 form a wedging lock 22, which is accommodated within the accommodating pocket 13 in the crushing roller 11, and the wedging lock 22 is located behind the arrangement of the crusher tooth 10, as seen in relation to the direction of rotation 17 of the crushing roller 11, said crusher tooth 10 having its tooth root 14 projecting into the accommodating pocket 13.

The wedging lock 22 has two pressure-exerting jaws 24, and a first pressure-exerting jaw 24 presses against a pocket wall of the accommodating pocket 13 and a further pressure-exerting jaw 24 presses against the crusher tooth 10. The wedging lock 22 has, in an arrangement between the pressure-exerting jaws 24, a rotary element 23, which can be rotated, for example through 90°, in the arrow direction shown. The rotary element 23 has a cam contour 29, which has an upwardly sloping radius as seen in relation to the axis of rotation of the rotary element 23 and slides against the inside of at least one pressure-exerting jaw 24 when the rotary element 23 is rotated. A rotary movement of the rotary element 23 is thus converted into a linear movement of the pressure-exerting jaws 24, and therefore the pressure-exerting jaws 24 are forced apart from one another slightly, this causing the wedging lock 22 to brace the crusher tooth 10 in the accommodating pocket 13. The bracing can be controlled here by the angle of rotation of the rotary element 23, and the rotary movement can be introduced into the rotary element 23 for example via a tool mount 25 and an associated tool. Purely to give a better illustration, the wedging lock 22 and the crusher tooth 10 are shown as being spaced apart from one another to a slight extent and as each being spaced to a slight extent from the walls of the accommodating pocket 13.

Designing the bracing means 15 in the form of a wedging lock 22 can make it possible for a crusher tooth 10 to be changed over quickly if the wedging lock 22 can be operated by straightforward means; in particular it may be sufficient to introduce a straightforward rotary movement into the rotary element 23 in order to release the crusher tooth 10.

The invention is not restricted, in design, to the preferred exemplary embodiment given above.

Rather, a number of variants which make use of the solution presented, even for embodiments of quite different type, are conceivable. All the advantages and/or features which can be gathered from the claims, the description or the drawings, including design details or spatial arrangements, may be essential to the invention both in themselves and in a wide variety of different combinations.

### LIST OF REFERENCE SIGNS

1 accommodating arrangement
10 crusher tooth
11 crushing roller
12 surface
13 accommodating pocket
14 tooth root
15 bracing means
16 pocket wall
17 direction of rotation
18 bracing wedge
19 screw-action element
20 pocket base
21 threaded bore
22 wedging lock
23 rotary element
24 pressure-exerting jaw
25 tool mount
26 projecting shaped portion
27 longitudinal direction of the tooth
28 negative wedge surface
29 cam contour

1.-10. (canceled)

11. An arrangement for receiving a crusher tooth on a crushing roller of a crusher, wherein the crusher tooth is used to generate a crushing action and projects at least partially out of a surface of the crushing roller, the arrangement comprising:
a receiving pocket incorporated in the crushing roller, wherein the receiving pocket receives a tooth root of the crusher tooth that extends into the receiving pocket; and
a bracing means disposed in the receiving pocket so as to be substantially or completely recessed relative to the surface of the crushing roller, wherein the bracing means braces the tooth root in the receiving pocket.

12. The arrangement of claim 11 wherein the tooth root and the bracing means are incorporated in the receiving pocket adjacent to one another.

13. The arrangement of claim 11 wherein the receiving pocket comprises a pocket wall, wherein the bracing means braces the tooth root against the pocket wall.

14. The arrangement of claim 11 wherein the bracing means is form fit to the tooth root.

15. The arrangement of claim 11 wherein the crushing roller rotates in a rotation direction, wherein the bracing means is disposed behind the crusher tooth in the receiving pocket relative to the rotation direction of the crushing roller.

16. The arrangement of claim 11 wherein the bracing means comprises a bracing wedge that braces against the tooth root by at least one screw-action member.

17. The arrangement of claim 16 wherein a base of the receiving pocket comprises a threaded bore in which the screw-action member is screwed to draw the bracing wedge into the receiving pocket towards the base of the receiving pocket.

18. The arrangement of claim 16 wherein the bracing wedge is braced away from a base of the receiving pocket by the screw-action member so as to generate a clamping action of the bracing wedge with the tooth root in the receiving pocket.

19. The arrangement of claim 11 wherein the bracing means comprises a wedging lock that has a rotary member and two pressure-exerting jaws, wherein the two pressure-exerting jaws are forced apart from one another by rotation of the rotary member so as to generate a clamping action of the tooth root in the receiving pocket.

20. The arrangement of claim 19 wherein the rotary member comprises a tool mount for engagement with a turning tool for manually and/or robotically adjusting the wedging lock between a closed position and an open position.

21. A crushing roller for a crusher, the crushing roller comprising:
a crusher tooth for comminuting material, the crusher tooth protruding from a surface of the crushing roller;
a receiving pocket disposed in the crushing roller, wherein the receiving pocket receives a tooth root of the crusher tooth; and
a bracing means disposed in the receiving pocket so as to be substantially or completely recessed relative to the surface of the crushing roller, the bracing means for securing the tooth root in the receiving pocket.

22. The crushing roller of claim 21 wherein the receiving pocket is a milled receiving pocket.

23. The crushing roller of claim 21 further comprising at least one optical or radio-technology system for detecting a position of at least one of the crusher teeth or the bracing means configured as a wedging lock.

24. The crushing roller of claim 21 further comprising a fastener for securing the bracing means in the receiving pocket.

25. The crushing roller of claim 24 further comprising a cover secured above the receiving pocket for protecting at least one of the bracing means or the fastener.
